(19) United States
(12) Patent Application Publication
(10) Pub. No.: US 2025/0182950 A1
(43) Pub. Date: Jun. 5, 2025

(54) INTEGRATED TRANSFORMER AND IC PACKAGES

(71) Applicant: Allegro MicroSystems, LLC, Manchester, NH (US)

(72) Inventors: Harry Chandra, Phoenix, AZ (US); Natasha Healey, Manchester, NH (US)

(73) Assignee: Allegro MicroSystems, LLC, Manchester, NH (US)

(21) Appl. No.: 18/524,132

(22) Filed: Nov. 30, 2023

(51) Int. Cl. H01F 27/255; H01F 27/02; H01F 27/28; H01F 27/32; H01F 41/04

(52) U.S. Cl. CPC H01F 27/255; H01F 27/022; H01F 27/2804; H01F 27/324; H01F 41/046

(57) ABSTRACT

A voltage-isolated transformer and integrated circuit package includes a substrate with opposed first and second surfaces and including a plurality of conductive traces, with a recess disposed in the second surface. The plurality of conductive traces includes a first group and a second group that are galvanically separate. A magnetic core is disposed on the first surface of the substrate. The magnetic core can include a soft ferromagnetic material. First and second coils are configured about the magnetic core and connected to the first and second groups of conductive traces, respectively, with the first and second coils and magnetic core being configured as a transformer. First and second integrated circuit die are disposed in the recess on the second surface. A dam is disposed on the first surface of the substrate and surrounding the magnetic core. An encapsulant disposed in the dam and encapsulating the magnetic core.

### BACKGROUND

Solid state switches typically include a transistor structure. The controlling electrode of the switch, usually referred to as its gate (or base), is typically controlled (driven) by a switch drive circuit, sometimes also referred to as gate drive circuit. Such solid state switches are typically voltage-controlled, turning on when the gate voltage exceeds a manufacturer-specific threshold voltage by a margin, and turning off when the gate voltage remains below the threshold voltage by a margin.

Switch drive circuits typically receive their control instructions from a controller such as a pulse-width-modulated (PWM) controller via one or more switch driver inputs. Switch drive circuits deliver their drive signals directly (or indirectly via networks of active and passive components) to the respective terminals of the switch (gate and source).

Some electronic systems, including ones with solid state switches, have employed galvanic isolation to prevent undesirable DC currents flowing from one side of an isolation barrier to the other. Such galvanic isolation can be used to separate circuits in order to protect users from coming into direct contact with hazardous voltages.

Various transmission techniques are available for signals to be sent across galvanic isolation barriers including optical, capacitive, and magnetic coupling techniques. Magnetic coupling typically relies on use of a transformer to magnetically couple circuits on the different sides of the transformer, typically referred to as the primary and secondary sides, while also providing galvanic separation of the circuits.

Transformers used for magnetic-coupling isolation barriers typically utilize a magnetic core to provide a magnetic path to channel flux created by the currents flowing in the primary and secondary sides of the transformer. Magnetic-coupling isolation barriers have been shown to have various drawbacks, including manufacturing problems, for integrated circuit (IC) packages due to the included magnetic core.

### SUMMARY

Aspects of the present disclosure are directed to integrated transformer and integrated circuit (IC) packages.

One general aspect includes a voltage-isolated integrated circuit (IC) package. The voltage-isolated integrated circuit can include: a substrate with opposed first and second surfaces and a plurality of conductive traces, where a recess is disposed in the second surface, and where the plurality of conductive traces includes a first group and a second group that are galvanically separate; a magnetic core disposed on the first surface of the substrate, where the magnetic core may include a soft magnetic material; first and second coils configured about the magnetic core and connected to the first and second groups of conductive traces, respectively, where the first and second coils and magnetic core are configured as a transformer; first and second integrated circuit (IC) die disposed in the recess on the second surface, where the first and second IC die are connected to the first and second groups of conductive traces, respectively; a dam disposed on the first surface of the substrate and surrounding the magnetic core; and an encapsulant disposed in the dam and encapsulating the magnetic core.

Implementations may include one or more of the following features. The dam of the IC package may include a plurality of walls disposed (e.g., four) on the first surface of the substrate. The walls may surround (partially or completely) the magnetic core. The dam may include a cover connecting the plurality of walls. The substrate may include a laminated structure. The substrate may include a printed circuit board (PCB). The PCB may include FR4, FR5, and/or another suitable substrate material. The substrate may include one or more layers of low-temperature cofired ceramic (LTCC) or high-temperature cofired ceramic (HTCC). The substrate may include an alumina substrate. The substrate may include a glass substrate may include one or more layers of metal and insulation. The first coil and/or second coil may include insulated wire. The first coil and/or second coil may include uninsulated wire. The first coil and/or second coil may include insulated ribbon cables. The first coil and/or second coil may include flexible ribbon cables. The first and second coils may be configured as primary and secondary coils in a step-up transformer configuration. The magnetic core may include ferrite. The magnetic core may include a nickel alloy. The magnetic core may include one or more soft ferromagnetic materials. The magnetic core may include iron particles. The encapsulant may include silicone. The first and second groups of conductive traces include a first plurality of exposed surfaces and a second plurality of exposed surfaces, respectively, configured to allow electrical connection (I/O functionality) to/for the IC package. The plurality of conductive traces (e.g., first and second groups of conductive traces) may include a first plurality of exposed surfaces and a second plurality of exposed surfaces, respectively, configured to allow thermal connection to the IC package.

Another general aspect of the present disclosure includes a method of making a voltage-isolated integrated circuit (IC) package. The method can include: providing a substrate with opposed first and second surfaces and including a plurality of conductive traces, where a recess is disposed in the second surface, and where the plurality of conductive traces includes a first group and a second group that are galvanically separate; providing a magnetic core disposed on the first surface of the substrate, where the magnetic core may include a soft magnetic material; providing first and second coils configured about the magnetic core and connected to the first and second groups of conductive traces, respectively, where the first and second coils and magnetic core are configured as a transformer; providing first and second integrated circuit (IC) die disposed in the recess on the second surface, where the first and second IC die are connected to the first and second groups of conductive traces, respectively; providing a dam disposed on the first surface of the substrate and surrounding the magnetic core; and providing an encapsulant disposed in the dam and encapsulating the magnetic core.

Implementations may include one or more of the following features. The dam may include a plurality of walls disposed on the first surface of the substrate. The dam may include a cover connecting the plurality of walls. The substrate may include a laminated structure. The substrate may include a printed circuit board (PCB). The substrate may include one or more layers of low-temperature cofired ceramic (LTCC) or high-temperature cofired ceramic (HTCC). The substrate may include an alumina substrate. The substrate may include a glass substrate, which may include one or more layers of metal and insulation. The first coil and/or second coil may include insulated wire. The first coil and/or second coil may include uninsulated wire. The first coil and/or second coil may include insulated ribbon cables. The first coil and/or second coil may include flexible ribbon cables. The first and second coils can be configured as primary and secondary coils in a step-up configuration. Providing the first and second IC die may include connecting the first and second IC die to the substrate with wire bonds. Providing the first and second IC die may include connecting the first and second IC die to the substrate using a flip chip attachment. The magnetic core may include ferrite. The magnetic core may include a nickel alloy or a silicon alloy, e.g., ferrosilicon. The magnetic core may include a soft ferromagnetic core. The magnetic core may include iron particles. The encapsulant may include silicone. The first and second groups of conductive traces include a first plurality of exposed surfaces and a second plurality of exposed surfaces, respectively, configured to allow electrical connection to the IC package. The plurality of conductive traces/structures (e.g., first and second groups of conductive traces) may include a first plurality of exposed surfaces and a second plurality of exposed surfaces, respectively, configured to allow thermal connection to the IC package.

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the present disclosure, which is susceptible of many embodiments. What follows is illustrative, but not exhaustive, of the scope of the present disclosure.

### BRIEF DESCRIPTION OF THE DRAWINGS

The manner and process of making and using the disclosed embodiments may be appreciated by reference to the figures of the accompanying drawings. In the figures like reference characters refer to like components, parts, elements, or steps/actions; however, similar components, parts, elements, and steps/actions may be referenced by different reference characters in different figures. It should be appreciated that the components and structures illustrated in the figures are not necessarily to scale, emphasis instead being placed upon illustrating the principals of the concepts described herein. Furthermore, embodiments are illustrated by way of example and not limitation in the figures, in which:

FIG. 1 is a perspective view of an example integrated circuit transformer and IC package, in accordance with the present disclosure;

FIG. 2 is a diagram including views (A)-(D) showing top, side, bottom, and perspective views of an example integrated transformer and IC package, in accordance with the present disclosure;

FIGS. 3A-3B show perspective views of an example integrated transformer and IC substrate package with and without an encapsulation layer, respectively, in accordance with the present disclosure; and

FIG. 4 shows a box diagram of an example method of fabricating an integrated transformer and IC package, in accordance with the present disclosure.

### DETAILED DESCRIPTION

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the inventive subject matter. The subject technology is susceptible of many embodiments. What follows is illustrative, but not exhaustive, of the scope of the subject technology.

Aspects of the present disclosure are directed to and include systems, structures, circuits, and methods providing integrated transformer and IC packages with transformer structures providing galvanic isolation (a.k.a., voltage isolation) for primary and secondary transformer sides, including and associated IC(s). Embodiments and examples can include ICs (packaged or unpackaged) configured for use in a package with a transformer. In some embodiments, a transformer may have, e.g., a step up, a step down, or a power transformer configuration.

One or more (e.g., first and second) semiconductor die having one or more integrated circuits (a.k.a., “IC die”) can be included in the packages. Such integrated circuits can include, e.g., but are not limited to, high-voltage circuits such as galvanically-isolated gate drivers configured to drive an external gate on a solid-state switch, e.g., a field effect transistor (FET), a metal oxide semiconductor FET (MOSFET), a metal semiconductor FET (MESFET), a gallium nitride FET (GaN FET), a high electron mobility transistor (HEMT), a silicon carbide FET (SIC FET), an insulated gate bipolar transistor (IGBT), or another load.

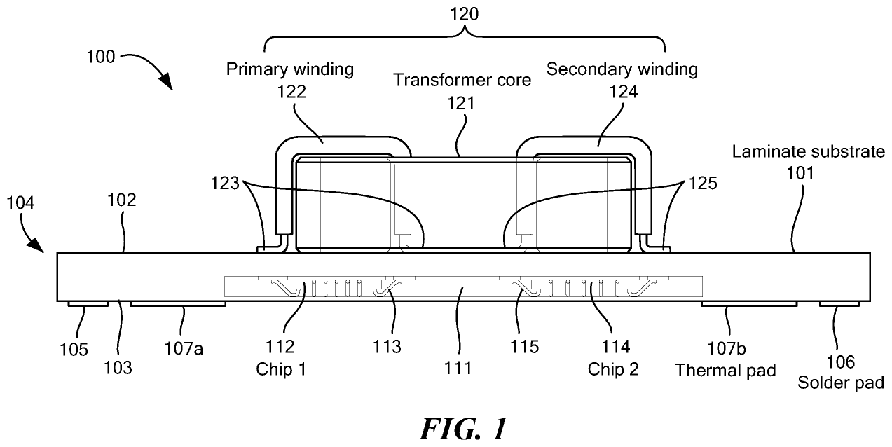

FIG. 1 is a perspective view of an example integrated circuit transformer and IC package, in accordance with the present disclosure. Package 100 includes a substrate 101 with opposed first and second surfaces (sides) 102, 103. Substrate 101 can include a laminated structure in some embodiments. Substrate 101 can include a plurality of conductive structures or traces 104, which may be on a surface of substrate 101 and/or included in the interior of substrate 101. The plurality of conductive traces can be made of or include any suitable conductive material(s); for example, in some embodiments, copper may be used. The plurality of conductive traces 104 can include a first group and a second group that are galvanically separate from one another. The first group can include a plurality of exposed portions that are exposed at a first area (or areas) of the substrate 101 and the second group can include a plurality of exposed portions that are exposed at a second area (or areas) of the substrate 101, e.g., as indicated by solder contacts (pads) 105 and 106, respectively. Substrate 101 can include a cavity or recess 111 on second surface (side) 103, as shown. First and second IC die 112, 114 can be disposed in recess 111. First and second IC die 112, 114 can be connected to substrate 101 with suitable connections, e.g., adhesive (not shown) and wirebonds 113 and 115, as shown. Thermally conductive thermal pads 107a-b may be present in some embodiments to facilitate removal of heat generated during operation of components of package 100.

In some embodiments, substrate 101 can include a printed circuit board (PCB), e.g., a PCB including FR4, FR5, or other PCB material(s). In some embodiments, substrate 101 can include one or more layers of low-temperature cofired ceramic (LTCC) or high-temperature cofired ceramic (HTCC). In some embodiments, substrate 101 can include an alumina substrate or a glass substrate comprising one or more layers of metal and insulation.

Package 100 also includes transformer 120 with primary coil 122 and secondary coil 124 configured about transformer core 121 and galvanically separated. Transformer core 121 can include one or more soft (referring to magnetic property) ferromagnetic materials. In some embodiments, core 121 can include ferrite, iron particles, ferrosilicon, nickel, nickel alloys (e.g., iron nickel), and/or the like. In some embodiments, core 121 can include a sintered soft ferromagnetic material. Primary coil 122 and secondary coil 124 can each have a desired number of windings, which may differ from coil to coil. Portions of primary and secondary coils 122 and 124 are shown configured (wound) about core 121 as insulated wire, with ends 123 and 125 connected to conductive structures 104 (not shown) on surface 102 and/or in substrate 101; other portions (not shown) of primary and secondary coils 122 and 124 are included (e.g., as conductive structures 104) within or on substrate 101 (e.g., as buried conductive traces), completing the windings of each coil 122, 124 about core 121. Insulating material (not shown) may be disposed between core 121 and substrate 101. Coils 122 and 124 can be connected, e.g., by way of conductive traces 104, to respective sets of connection structures, e.g., solder contacts (pads) 105 and 106, respectively.

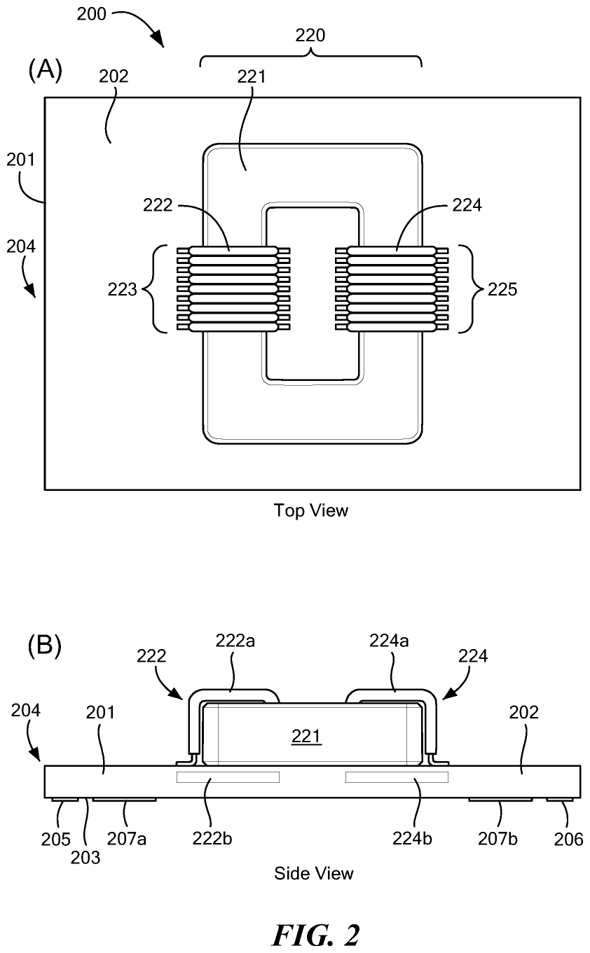

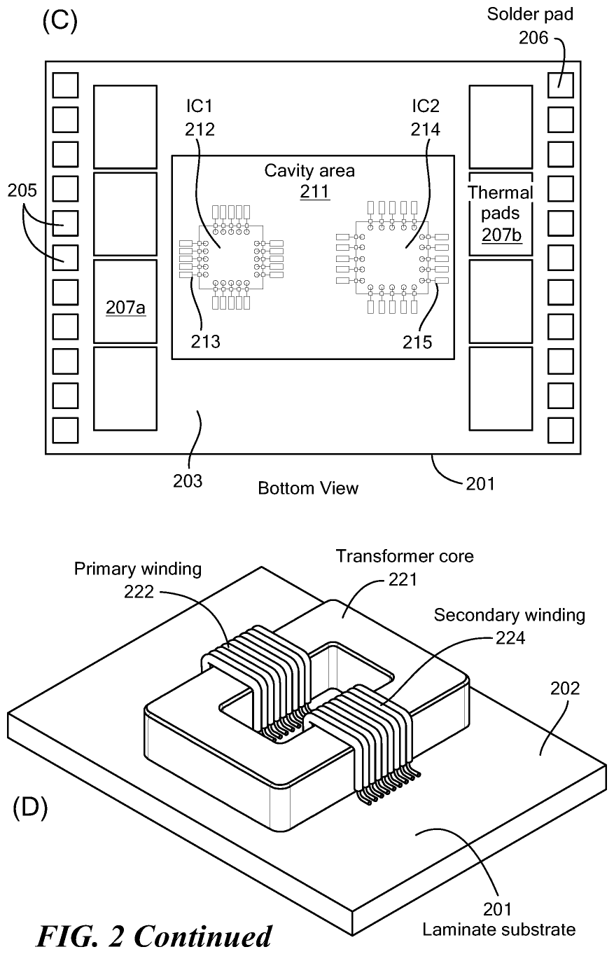

FIG. 2 is a diagram including views (A)-(D) showing top, side, bottom, and perspective views, respectively, of an example integrated transformer and IC package 200, in accordance with the present disclosure.

As shown in view (A), package 200 includes a substrate 201 with opposed first and second surfaces (sides) 202, 203. Substrate 201 can include a laminated structure in some embodiments. Substrate 201 can include a plurality of conductive structures or traces 204, which may be on a surface of substrate 201 (e.g., side 202) and/or included in the interior of substrate 201. The plurality of conductive traces 204 can include a first group and a second group that are galvanically separate from one another. In some embodiments, substrate 201 can include a printed circuit board (PCB), e.g., a PCB including FR4, FR5, or other PCB material(s). In some embodiments, substrate 201 can include one or more layers of low-temperature cofired ceramic (LTCC) or high-temperature cofired ceramic (HTCC). In some embodiments, substrate 201 can include an alumina substrate or a glass substrate comprising one or more layers of metal and insulation.

Package 200 also includes transformer 220 with primary coil 222 and secondary coil 224 configured about transformer core 221 and galvanically separated. Transformer core 221 can include one or more soft (referring to magnetic property) ferromagnetic materials. In some embodiments, core 221 can include ferrite, iron particles, ferrosilicon, nickel, nickel alloys (e.g., iron nickel), and/or the like. In some embodiments, core 221 can include a sintered soft ferromagnetic material. Primary coil 222 and secondary coil 224 can each have a desired number of windings, which may differ from coil to coil. Portions of primary and secondary coils 222 and 224 are shown configured (wound) about core 221 as insulated wire, with ends 223 and 225 connected to conductive structures 204 (not shown) on surface 202 and/or in substrate 201; other portions (not shown) of primary and secondary coils 222 and 224 are included (e.g., as conductive structures 204) within or on substrate 201, e.g., as buried conductive traces—as shown in view (B)—completing the windings of each coil 222, 224 about core 221. Insulating material (not shown) may be disposed between core 221 and substrate 201. Coils 222 and 224 can be connected, e.g., by way of conductive structures or traces 204, to respective sets of connection structures, e.g., solder contacts (pads) 205 and 206, respectively.

View (B) shows a side (cross section) view of package 200, including substrate 201, core 220, and coils 222, 224. Each of coils 222, 224 includes portions exterior to core 201, i.e., portions 222a and 224a, respectively, and portions interior to (or on a surface of) core 201, i.e., portions 222b and 224b, respectively, as shown. Portions 222b and 224b may be included in the first and second groups of conductive structure 204 and galvanically separated. The first group of conductive structure or traces 204 can include a plurality of exposed portions, e.g., on surface 203, that are exposed at a first area (or areas) of the substrate 201 and the second group can include a plurality of exposed portions that are exposed at a second area (or areas) of the substrate 201, e.g., on surface 203, as indicated by solder contacts (pads) 205 and 206, respectively. Thermally conductive thermal pads 207a-b may be present in some embodiments to facilitate removal of heat generated during operation of components of package 200.

As shown in view (C), substrate 201 can include a cavity or recess 211 on second surface (side) 203, as shown. First and second IC die 212, 214 can be disposed in recess 211. First and second IC die 212, 214 can be connected to substrate 201 with suitable connections, e.g., adhesive (not shown) and wirebonds 213 and 215, as shown.

View (D) shows a top (isometric) view of package 200. As described in further detail below, a wall may be added for holding encapsulant material to facilitate protection/isolation of core 221 and/or coils 222, 224.

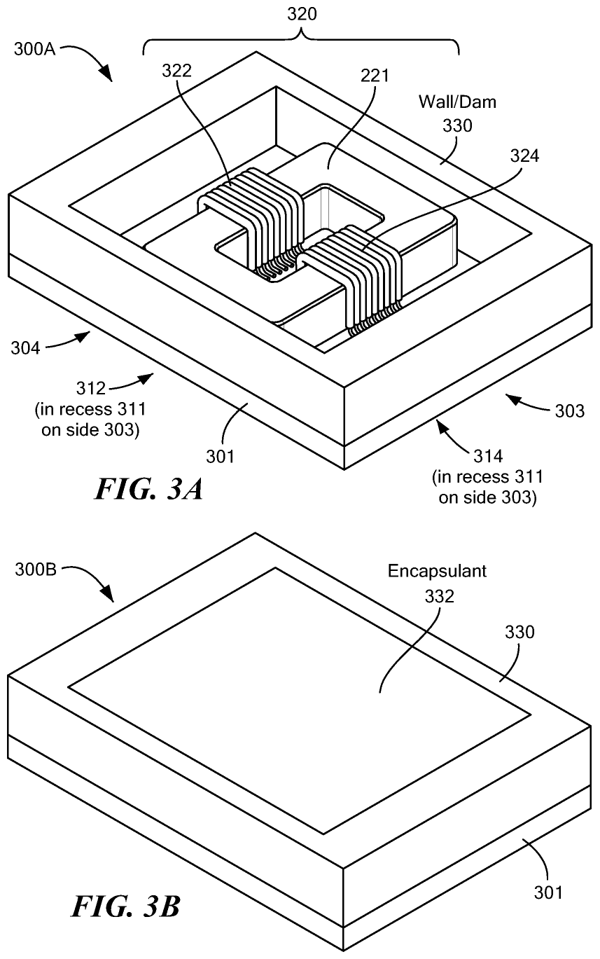

FIGS. 3A-3B show perspective views of an example integrated transformer and IC substrate package 300 with and without an encapsulation layer, respectively, in accordance with the present disclosure.

As shown in FIG. 3A, package 300 includes a substrate 301 with opposed first and second surfaces (sides) 302, 303. Substrate 301 can include a laminated structure in some embodiments. Substrate 301 can include a plurality of conductive structures or traces 304, which may be on a surface of substrate 301 and/or included in the interior of substrate 301. The plurality of conductive traces 304 can include a first group and a second group that are galvanically separate from one another. The first group can include a plurality of exposed portions that are exposed at a first area (or areas) of the substrate 301 and the second group can include a plurality of exposed portions that are exposed at a second area (or areas) of the substrate 301, e.g., as indicated by solder contacts (pads) 305 and 306, respectively. Substrate 301 can include a cavity or recess 311 on second surface (side) 303, as shown. First and second IC die 312, 314 can be disposed in recess 311 on side 303.

Package 300 also includes transformer 320 with primary coil 322 and secondary coil 324 configured about transformer core 321 and galvanically separated. Transformer core 321 can include one or more soft (referring to magnetic property) ferromagnetic materials. In some embodiments, core 321 can include ferrite, iron particles, ferrosilicon, nickel, nickel alloys (e.g., iron nickel), and/or the like. In some embodiments, core 321 can include a sintered soft ferromagnetic material. Primary coil 322 and secondary coil 324 can each have a desired number of windings, which may differ from coil to coil. Portions of primary and secondary coils 322 and 324 are shown configured (wound) about core 321 as insulated wire, with ends connected to conductive structures 304 (not shown) on surface 302 and/or in substrate 301; other portions (not shown) of primary and secondary coils 322 and 324 are included (e.g., as conductive structures 304) within or on substrate 301 (e.g., as buried conductive traces), completing the windings of each coil 322, 324 about core 321. Insulating material (not shown) may be disposed between core 321 and substrate 301. Coils 322 and 324 can be connected, e.g., by way of conductive traces 304, to respective sets of connection structures, e.g., solder contacts (pads).

FIG. 3B shows wall or dam 330 disposed on substrate 301, e.g., on a perimeter of substrate 301, and surrounding core 321. In some embodiments, wall/dam 330 can completely surround core 321, e.g., with multiple connected sidewalls (sides). In some embodiments, wall/dam 330 may include structure (e.g., walls) that only partially surround core 321. In some embodiments, a cover/lid (not shown) may be included, e.g., joined to wall/dam 330 to enclose encapsulant 332. One or more encapsulant materials 332 may be included within dam/wall 330. Encapsulant(s) 332 may facilitate protection and/or isolation of core 321 and/or coils 322, 324. Examples of encapsulant(s) may include, but are not limited to, silicone gels, dielectric (epoxy) materials, potting materials, or the like.

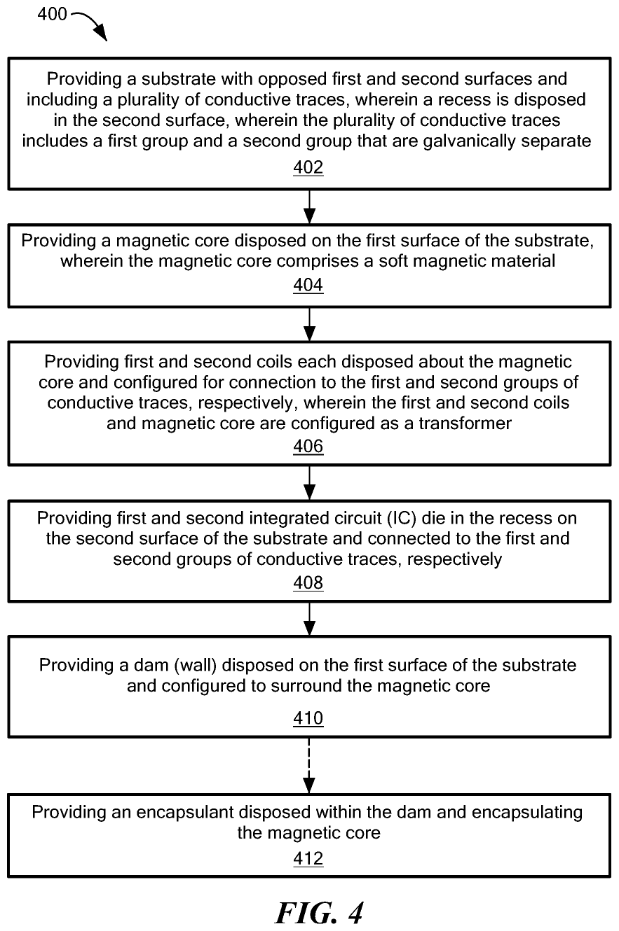

FIG. 4 shows a box diagram of an example method 400 of fabricating an integrated transformer and IC package, in accordance with the present disclosure. Method 400 can include providing a substrate with opposed first and second surfaces and including a plurality of conductive traces, wherein a recess is disposed in the second surface, wherein the plurality of conductive traces includes a first group and a second group that are galvanically separate, as described at 402. A substrate may include a laminated substrate material. In some embodiments, a substrate may include a PCB, e.g., a PCB including FR4, FR5, or other PCB material(s). In some embodiments, a substrate can include one or more layers of low-temperature cofired ceramic (LTCC) or high-temperature cofired ceramic (HTCC). In some embodiments, a substrate can include an alumina substrate or a glass substrate comprising one or more layers of metal and insulation.

A magnetic core can be provided that is disposed on the first surface of the substrate, with the magnetic core including a soft ferromagnetic material, as described at 404. In some embodiments, a core can include ferrite, iron particles, ferrosilicon, nickel, nickel alloys (e.g., iron nickel), and/or the like. In some embodiments, a core can include a sintered soft ferromagnetic material or materials. First and second transformer coils can be provided with each disposed about the magnetic core and configured for connection to the first and second groups of conductive traces, respectively, with the first and second coils and magnetic core being configured as a transformer, as described at 406.

First and second integrated circuit (IC) die (packaged or unpackaged) can be provided in the recess on the second surface of the substrate and connected to the first and second groups of conductive traces, respectively, as described at 408. In some embodiments, an IC die can include a gate driver, e.g., connected to the secondary side of a transformer in a step up configuration. A dam or wall can be disposed on the first surface of the substrate and configured to surround or partially surround the magnetic core, as described at 410. An encapsulant can be provided and disposed within the dam and encapsulating the magnetic core, as described at 412. In some embodiments, an encapsulant can include a silicone gel, a potting material, a dielectric material, and/or an epoxy, etc.

In some examples and/or embodiments, integrated circuits (ICs), e.g., IC die 212 and 214 in FIG. 2, or other conductive features of the primary and secondary sides of a transformer in an integrated transformer and IC package, according to the present disclosure can be fabricated or configured to have a desired separation distance (d) between certain parts or features, e.g., to meet internal creepage or external clearance requirements for a given pollution degree rating as defined by certain safety standards bodies such as the Underwriters Laboratories (UL) and the International Electrotechnical Commission (IEC). For example, a separation distance may be between closest (voltage) points of the respective circuits, e.g., the low-voltage (primary) side and high-voltage (secondary) side. For further example, such a separation distance may be the distance between any two voltage points between the primary and secondary sides or a distance between exposed leads connected to the die connected to primary and secondary sides of a transformer, may be, may be approximately, or may be at least 1.2 mm, 1.4 mm, 1.5 mm, 3.0 mm, 4.0 mm, 5.5 mm, 7.2 mm, 8.0 mm, 10 mm, or 10+mm in respective examples. Such a distance between conductive portions or areas of die can include any insulation covering a conductor, e.g., such as plastic coating of a wire/lead. Other distances between conductive parts, components, and/or features of an IC/transformer package may also be designed and implemented, e.g., to meet desired internal creepage, voltage breakdown, or external clearance requirements, e.g., between external leads.

In some examples and embodiments, one or more dielectric materials (e.g., a gel and/or a solid) may be used for potting and/or protecting substrate (e.g., PCB) systems, assemblies, and/or packages, to protect die, transformer components (e.g., core and/or coils), and/or interconnects from environment conditions and/or to provide dielectric insulation. In some examples and embodiments, one or more suitable non-gel dielectric materials may be used for potting or protecting package such components and/or structures. In some examples, a dielectric material may include, but is not limited to, one or more of the following materials: DOWSIL™ EG-3810 Dielectric Gel (made available by The Dow Chemical Corporation, a.k.a., “Dow”), and/or DOWSIL™ EG-3896 Dielectric Gel (made available by Dow), which has the ability to provide isolation greater than 20 kV/mm. Other suitable gel materials may also or instead be used, e.g., to meet or facilitate meeting/achieving voltage isolation specifications required by a given package design. DOWSIL™ EG-3810 is designed for temperature ranges from −60° C. to 200° C. and DOWSIL™ EG-3896 Dielectric Gel −40° C. to +185° C.; both of which can be used to meet typical temperature ranges for automotive applications.

Accordingly, embodiments and/or examples of the inventive subject matter can afford various benefits relative to prior art techniques. For example, embodiments and examples of the present disclosure can enable or facilitate use of smaller size packages for a given power, current. or voltage rating. Embodiments and examples of the present disclosure can enable or facilitate lower costs and higher scalability for manufacturing of IC and/or transformer packages/modules having voltage-isolated (galvanic isolation) IC die and transformers.

Various embodiments of the concepts, systems, devices, structures, and techniques sought to be protected are described above with reference to the related drawings. Alternative embodiments can be devised without departing from the scope of the concepts, systems, devices, structures, and techniques described.

It is noted that various connections and positional relationships (e.g., over, below, adjacent, etc.) may be used to describe elements and components in the description and drawings. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, positioning element “A” over element “B” can include situations in which one or more intermediate elements (e.g., element “C”) is between elements “A” and elements “B” as long as the relevant characteristics and functionalities of elements “A” and “B” are not substantially changed by the intermediate element(s).

Also, the following definitions and abbreviations are to be used for the interpretation of the claims and the specification. The terms “comprise,” “comprises,” “comprising,” “include,” “includes,” “including,” “has,” “having,” “contains” or “containing,” or any other variation are intended to cover a non-exclusive (open-ended) inclusion. For example, an apparatus, a method, a composition, a mixture, or an article, which includes a list of elements is not necessarily limited to only those elements but can include other elements not expressly listed or inherent to such apparatus, method, composition, mixture, or article.

Additionally, the term “exemplary” means “serving as an example, instance, or illustration.” Any embodiment or design described as “exemplary” is not necessarily to be construed as preferred or advantageous over other embodiments or designs. The terms “one or more” and “at least one” indicate any integer number greater than or equal to one, i.e., one, two, three, four, etc. The term “plurality” indicates any integer number greater than one. Those terms, however, may refer to fractional numbers/values where context admits; for example, in some embodiments, the number of windings of a coil may be referenced by the terms “one or more,” “at least one,” or “a plurality” and can include a fractional value/number, e.g., 1.5, 2.66, 3.33, 4.75, etc. The term “connection” can include an indirect connection and a direct connection.

References in the specification to “embodiments,” “one embodiment, “an embodiment,” “an example embodiment,” “an example,” “an instance,” “an aspect,” etc., indicate that the embodiment described can include a particular feature, structure, or characteristic, but every embodiment may or may not include the particular feature, structure, or characteristic. Moreover, such phrases do not necessarily refer to the same embodiment. Further, when a particular feature, structure, or characteristic is described in connection with an embodiment, it may affect such feature, structure, or characteristic in other embodiments whether explicitly described or not.

Relative or positional terms including, but not limited to, the terms “upper,” “lower,” “right,” “left,” “vertical,” “horizontal, “top,” “bottom,” and derivatives of those terms relate to the described structures and methods as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another, or a temporal order in which acts of a method are performed but are used merely as labels to distinguish one claim element having a certain name from another element having a same name (but for use of the ordinal term) to distinguish the claim elements.

The terms “approximately” and “about” may be used to mean within ±20% of a target (or nominal) value in some embodiments, within plus or minus (±) 10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

The disclosed subject matter is not limited in its application to the details of construction and to the arrangements of the components set forth in the following description or illustrated in the drawings. The disclosed subject matter is capable of other embodiments and of being practiced and carried out in various ways.

Also, the phraseology and terminology used in this patent are for the purpose of description and should not be regarded as limiting. As such, the conception upon which this disclosure is based may readily be utilized as a basis for the designing of other structures, methods, and systems for carrying out the several purposes of the disclosed subject matter. Therefore, the claims should be regarded as including such equivalent constructions as far as they do not depart from the spirit and scope of the disclosed subject matter.

Although the disclosed subject matter has been described and illustrated in the foregoing exemplary embodiments, the present disclosure has been made only by way of example. Thus, numerous changes in the details of implementation of the disclosed subject matter may be made without departing from the spirit and scope of the disclosed subject matter.

Accordingly, the scope of this patent should not be limited to the described implementations but rather should be limited only by the spirit and scope of the following claims.

All publications and references cited in this patent are expressly incorporated by reference in their entirety.

What is claimed is:

1. A voltage-isolated integrated circuit (IC) package comprising:
a substrate with opposed first and second surfaces and including a plurality of conductive traces, wherein a recess is disposed in the second surface, wherein the plurality of conductive traces includes a first group and a second group that are galvanically separate;
a magnetic core disposed on the first surface of the substrate, wherein the magnetic core comprises a soft magnetic material;
first and second coils configured about the magnetic core and connected to the first and second groups of conductive traces, respectively, wherein the first and second coils and magnetic core are configured as a transformer;
first and second integrated circuit (IC) die disposed in the recess on the second surface, wherein the first and second IC die are connected to the first and second groups of conductive traces, respectively;
a dam disposed on the first surface of the substrate and surrounding the magnetic core; and
an encapsulant disposed in the dam and encapsulating the magnetic core.

2. The IC package of claim 1, wherein the dam comprises a plurality of walls disposed on the first surface of the substrate.

3. The IC package of claim 2, wherein the dam further comprises a cover connecting the plurality of walls.

4. The IC package of claim 1, wherein the substrate comprises a laminated structure.

5. The IC package of claim 1, wherein the substrate comprises a printed circuit board (PCB).

6. The IC package of claim 5, wherein the PCB comprises FR4.

7. The IC package of claim 5, wherein the PCB comprises FR5.

8. The IC package of claim 1, wherein the substrate comprises one or more layers of low-temperature cofired ceramic (LTCC) or high-temperature cofired ceramic (HTCC).

9. The IC package of claim 1, wherein the substrate comprises an alumina substrate.

10. The IC package of claim 1, wherein the substrate comprises a glass substrate comprising one or more layers of metal and insulation.

11. The IC package of claim 1, wherein the first and/or second coil comprises insulated wire.

12. The IC package of claim 1, wherein the first and/or second coil comprises uninsulated wire.

13. The IC package of claim 1, wherein the first and/or second coil comprises insulated ribbon cables.

14. The IC package of claim 1, wherein the first and/or second coil comprises flexible ribbon cables.

15. The IC package of claim 1, wherein the first and second coils are configured as primary and secondary coils in a step-up transformer configuration.

16. The IC package of claim 1, wherein the magnetic core comprise ferrite.

17. The IC package of claim 1, wherein the magnetic core comprises a nickel alloy.

18. The IC package of claim 1, wherein the magnetic core comprises a ferromagnetic core.

19. The IC package of claim 1, wherein the magnetic core comprises iron particles.

20. The IC package of claim 1, wherein the encapsulant comprises silicone.

21. The IC package of claim 1, wherein the first and second groups of conductive traces include a first plurality of exposed surfaces and a second plurality of exposed surfaces, respectively, configured to allow electrical connection to the IC package.

22. The IC package of claim 1, wherein the first and second groups of conductive traces include a first plurality of exposed surfaces and a second plurality of exposed surfaces, respectively, configured to allow thermal connection to the IC package.

23. A method of making a voltage-isolated integrated circuit (IC) package, the method comprising:
providing a substrate with opposed first and second surfaces and including a plurality of conductive traces, wherein a recess is disposed in the second surface, wherein the plurality of conductive traces includes a first group and a second group that are galvanically separate;
providing a magnetic core disposed on the first surface of the substrate, wherein the magnetic core comprises a soft magnetic material;
providing first and second coils configured about the magnetic core and connected to the first and second groups of conductive traces, respectively, wherein the first and second coils and magnetic core are configured as a transformer;
providing first and second integrated circuit (IC) die disposed in the recess on the second surface, wherein the first and second IC die are connected to the first and second groups of conductive traces, respectively;
providing a dam disposed on the first surface of the substrate and surrounding the magnetic core; and
providing an encapsulant disposed in the dam and encapsulating the magnetic core.

24. The method of claim 23, wherein the dam comprises a plurality of walls disposed on the first surface of the substrate.

25. The method of claim 24, wherein the dam further comprises a cover connecting the plurality of walls.

26. The method of claim 23, wherein the substrate comprises a laminated structure.

27. The method of claim 23, wherein the substrate comprises a printed circuit board (PCB).

28. The method of claim 23, wherein the substrate comprises one or more layers of low-temperature cofired ceramic (LTCC) or high-temperature cofired ceramic (HTCC).

29. The method of claim 23, wherein the substrate comprises an alumina substrate.

30. The method of claim 23, wherein the substrate comprises a glass substrate comprising one or more layers of metal and insulation.

31. The method of claim 23, wherein the first and/or second coil comprises insulated wire.

32. The method of claim 23, wherein the first and/or second coil comprises uninsulated wire.

33. The method of claim 23, wherein the first and/or second coil comprises insulated ribbon cables.

34. The method of claim 23, wherein the first and/or second coil comprises flexible ribbon cables.

35. The method of claim 23, wherein the first and second coils are configured as primary and secondary coils in a step-up configuration.

36. The method of claim 23, wherein providing the first and second IC die comprises connecting the first and second IC die to the substrate with wire bonds.

37. The method of claim 23, wherein providing the first and second IC die comprises connecting the first and second IC die to the substrate using a flip chip attachment.

38. The method of claim 23, wherein the magnetic core comprise ferrite.

39. The method of claim 23, wherein the magnetic core comprises a nickel alloy.

40. The method of claim 23, wherein the magnetic core comprises a ferromagnetic core.

41. The method of claim 23, wherein the magnetic core comprises iron particles.

42. The method of claim 23, wherein the encapsulant comprises silicone.

43. The method of claim 23, wherein the first and second groups of conductive traces include a first plurality of exposed surfaces and a second plurality of exposed surfaces, respectively, configured to allow electrical connection to the IC package.

44. The method of claim 23, wherein the first and second groups of conductive traces include a first plurality of exposed surfaces and a second plurality of exposed surfaces, respectively, configured to allow thermal connection to the IC package.
